(19) United States
(12) Patent Application Publication
(10) Pub. No.: US 2008/0251606 A1
(43) Pub. Date: Oct. 16, 2008

(54) Air Spray Gun Improvements in Nozzle and Aircap

(76) Inventors: Michael E. Bloom, Oak Grove, MN (US); Thomas P. Daley, Golden Valley, MN (US); Tera D. Brezny, Lino Lakes, MN (US)

Correspondence Address: GRACO MINNESOTA INC, PO BOX 1441, MINNEAPOLIS, MN, 55440, US

(21) Appl. No.: 10/597,399

(22) PCT Filed: Mar. 24, 2005
(86) PCT No.: PCT/US05/09852

§ 371 Date: Jul. 24, 2006

Related U.S. Application Data
(60) Provisional application No. 60/557,103, filed on Mar. 26, 2004.

(51) Int. Cl. B05B 1/28; B05B 7/00

(52) U.S. Cl. 239/265.19; 239/296

(57) ABSTRACT

The feeder passages (22) in the aircap (20) of an air spray gun (10) arc slots which are significantly wider than the horn exit holes (24). This construction makes centerline offset much more forgiving by providing a consistent intersection of the passages. The feeder passages (22) are also deeper in that they extent past the intersection point (26) again making them more forgiving of irregularities. Sealing and seating of the nozzle (18) to the fluid inlet (16) have also been improved over the prior art. In the instant invention, o-rings (28) seal the nozzle (18) to the fluid inlet (16) and allow the shoulder (18b) of the nozzle (18) to seat squarely on the spray housing (14) controlling angularity.

### TECHNICAL FIELD

This application claims the benefit of U.S. Application Ser. No. 60/557,103, filed Mar. 26, 2004.

### BACKGROUND ART

Airspray guns (including HVLP and compliant variants) for spraying paints and coatings are well known tools for achieving a high quality finish.

### DISCLOSURE OF THE INVENTION

It is an object of this invention to provide such a spray gun which will yield improved spray results and which will be more consistently manufacturable to high standards.

The feeder passages in the aircap are slots which are significantly wider than the horn exit holes. This construction makes centerline offset much more forgiving by providing a consistent intersection of the passages. The feeder passages are also deeper in that they extent past the intersection point again making them more forgiving of irregularities.

Sealing and seating of the nozzle to the fluid inlet have also been improved over the prior art. Prior art designs allow the nozzle to float within the spray housing and seat firmly against the fluid inlet. In this prior art, attachment of the aircap to the spray housing did not adequately control concentricity of the two critical parts. In the instant invention, o-rings seal the nozzle to the fluid inlet and allow the shoulder of the nozzle to seat squarely on the spray housing controlling angularity.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a cross-section of the front end of the spray gun of the instant invention.

FIG. 2 is a side view of the aircap of the prior art.

FIG. 3 is a sectional view taken along line 3-3 of FIG. 2.

FIG. 4 is a side view of the aircap of the instant invention.

FIG. 5 is a sectional view taken along line 5-5 of FIG. 4.

FIG. 6 is a side view of the aircap of the instant invention.

FIG. 7 is a sectional view taken along line 7-7 of FIG. 6.

### BEST MODE FOR CARRYING OUT THE INVENTION

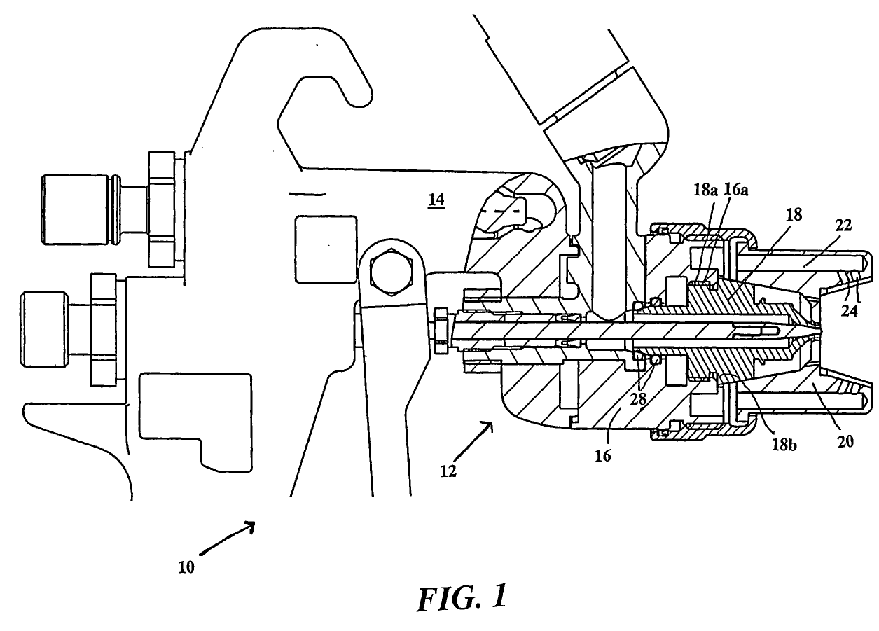

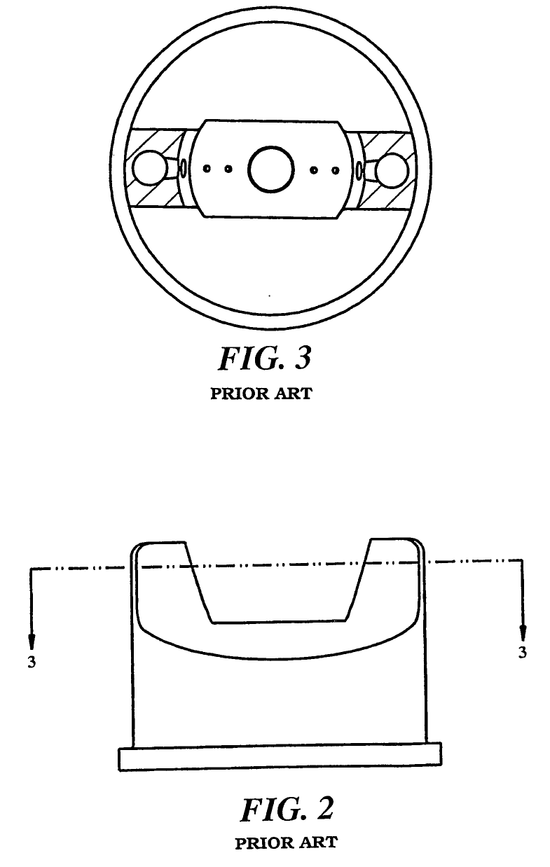

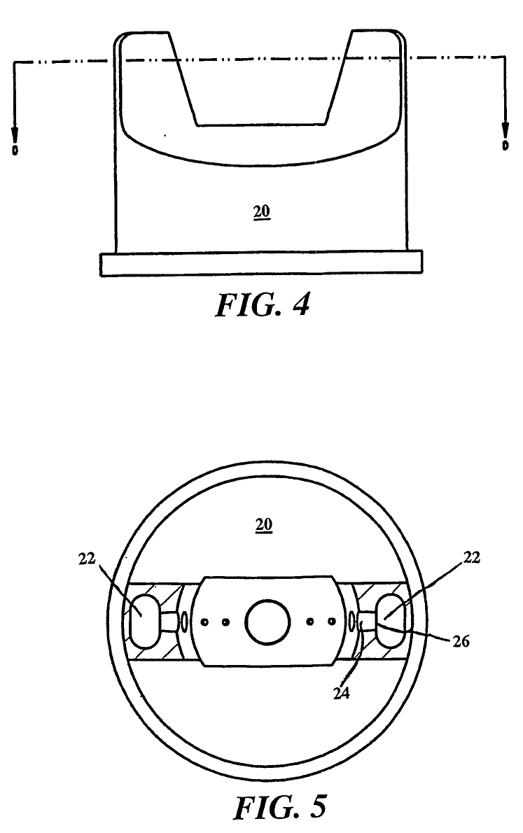

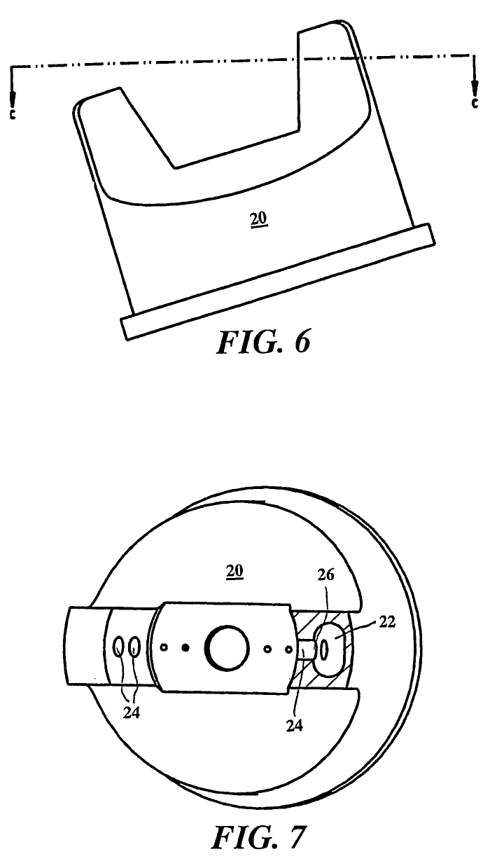

The front end 12 of an air spray gun 10 is shown in FIG. 1. The general parts of the spray gun are the spray housing 14, a fluid inlet 16, a nozzle 18 and an aircap 20.

The feeder passages 22 in the aircap 20 are slots which are significantly wider than the horn exit holes. In the preferred embodiment, the slots 22 have a width of between two and three times the diameter or width of the horn exit holes 24. This construction makes centerline offset much more forgiving by providing a consistent intersection of the passages. The feeder passages 22 are also deeper in that they extent past the intersection point 26 again making them more forgiving of irregularities.

Sealing and seating of the nozzle 18 to the fluid inlet 16 have also been improved over the prior art. Prior art designs allow the nozzle to float within the spray housing and seat firmly against the fluid inlet. In this prior art, attachment of the aircap to the spray housing did not adequately control concentricity of the two critical parts. In the instant invention, o-rings 28 seal the nozzle 18 to the fluid inlet 16 and allow the shoulder 18b of the nozzle 18 to seat squarely on the spray housing controlling angularity. Fine threads 18a and 16a on the nozzle 18 and fluid inlet 16 respectively provide further control of angularity and concentricity.

It is contemplated that various changes and modifications may be made to the spray gun without departing from the spirit and scope of the invention as defined by the following claims.

1. In an aircap for an airspray gun having feeder passages which intersect with horn exit holes, said feeder passages and said horn exit holes each having widths, the improvement comprising said feeder passage widths being substantially greater than said horn exit hole widths.

2. The aircap of claim 1 wherein said feeder passage widths are at least twice as wide as said horn exit hole widths

3. In an aircap for an airspray gun having feeder passages which intersect with horn exit holes, said feeder passages having depths, the improvement comprising said feeder passage depths extending past the points of intersection with said horn exit holes.

4. In an air spray gun having a spray housing, a fluid inlet, a nozzle threaded into said fluid housing and an aircap, the improvement comprising a plurality of o-rings sealing said nozzle to said fluid inlet, said nozzle having a shoulder seating squarely on said spray housing to control angularity.
